(19) United States
(12) Patent Application Publication
(10) Pub. No.: US 2003/0058371 A1
(43) Pub. Date: Mar. 27, 2003

(54) Image display apparatus for improving the display of moving images

(76) Inventor: Geoffrey Howard Blackham, Hassocks (GB)

Correspondence Address: Iandiorio & Teska, 260 Bear Hill Road, Waltham, MA, 02154, US

(21) Appl. No.: 10/168,462

(22) PCT Filed: Oct. 19, 2001
(86) PCT No.: PCT/GB01/04678

(30) Foreign Application Priority Data
Oct. 20, 2000 (GB) 0025795.6

(51) Int. Cl. H04N 5/74

(52) U.S. Cl. 348/756

(57) ABSTRACT

Image display apparatus (10) for improving the display of moving images, which image display apparatus comprises control means (16) for eliminating or reducing smear caused primarily by a zero-order hold characteristic of a light-valve image display device (10), the control means (16) being such that it eliminates or reduces the zero-order hold characteristic by superimposing a decay characteristic onto light incident upon the light-valve image display device (10), and the control means (10) being such that it superimposes the decay characteristic by reducing the pixel intensity before the pixel intensity is updated in a next frame.

This invention relates to image display apparatus and, more especially, this invention relates to image display apparatus for improving the display of moving images.

Image display apparatus is used to display images for applications such for example as entertainment, training and education. For these applications, it is desirable to have a high-resolution display. Resolution is the ability to discern fine detail within an image. At present, there are various known different display techniques used for these applications. Examples of two known different display technologies are cathode ray tube image display apparatus and liquid crystal display apparatus.

Historically, the resolution of a display has been determined on a static image. This is because the difference between dynamic and static resolution on a cathode ray tube display is minimal. With the introduction of new technology such for example as liquid crystal displays, the difference between static and dynamic resolution has become significant.

In cathode ray tube image display apparatus, an electron beam is scanned across a phosphor surface causing the phosphor to emit light and form an image. The cathode ray tube spot size and the bandwidth of drive electronics limit the resolution of such image display apparatus. Current technology is capable of providing typically 1200 active lines per frame, each line having 1600 active pixels at a frame rate of 60 Hz. The light output rise time is short in cathode ray tube displays, and its decay time is typically less than half a frame period, causing the image to decay to black between each frame update. This produces the effect of a band of light scanning down the display. The short persistence can result in large area flicker with frame rates lower than 60 Hz. However, the short persistence prevents the smearing effects present in certain new display technologies such as liquid crystal displays.

Fixed matrix technology such for example as liquid crystal displays, addresses individual pixels within a panel. The resolution of the display is fixed and dependent on the number of pixels within the panel. Any source video formats not of native panel resolution require scan conversion before display.

One particular class of liquid crystal display that is in common use may be referred to as sequentially scanned, where each pixel is addressed in turn as part of a line and frame structure. When addressed, each liquid crystal display element that forms the pixel has a new polarisation state set which, in combination with pre- and post-polarisers, results in a pixel intensity modulated by the source video signal. The pre-polariser is usually known simply as the polariser, and the post-polariser as the analyser. To improve contrast in displays with larger numbers of pixels, a thin film transistor may be sited at each pixel in order to maintain the required state of the pixel for the whole frame period. Such displays are known as active matrix thin film transistor liquid crystal displays. Whilst this technology is highly successful in mainstream presentation applications, it suffers from poor rendition of dynamic scenes. This is related primarily to the following two characteristics.

The first characteristic is that pixel intensity does not decay between frame updates. This may be described mathematically as a zero order hold. On a display device with zero rise and fall times, a moving image would be fully modulated from one frame to the next, as a pixel from the first frame would extinguish just as the corresponding pixel of the next frame illuminates. In spite of this, when the eye is smoothly tracking a moving image, the image appears to smear along the direction of motion. The eye follows the average position of the image, whereas the image stays put for a whole frame period, then instantaneously jumps to its position for its next frame. Because the eye is moving while the display is static, the image of the display moves across the retina during this period. When combined with persistence of vision, this results in the perception of smear.

The second characteristic is that pixel rise and fall times in practice are significantly greater than zero. This can appear to soften edges in high contrast images. Consider a pixel that is instructed to illuminate for one frame and then extinguish. The integrated pixel intensity in the first frame is reduced by a factor dependent on the rise time. In the subsequent frame, excess pixel intensity results from residual light due to the finite fall time. If, for example, a white square moves across a black background, the leading edge of the square will fall short of full white while the trailing edge will lag behind. The overall appearance will be of edge softening and smear. The effect is variable depending upon the velocity of the moving square.

Various techniques are known for improving the response time of liquid crystal displays. One example is to run the liquid crystal at higher temperature, thereby lowering its viscosity. However, these techniques tackle only part of the problem, since they do not address the zero order hold issues.

It is an aim of the present invention to reduce or eliminate the component of smear due to the zero hold characteristic.

Accordingly, the present invention provides image display apparatus for improving the display of moving images, which image display apparatus comprises control means for eliminating or reducing smear caused primarily by a zero-order hold characteristic of a light-valve image display device, the control means being such that it eliminates or reduces the zero-order hold characteristic by superimposing a decay characteristic onto light incident upon the light-valve image display device, and the control means being such that it superimposes the decay characteristic by reducing the pixel intensity before the pixel intensity is updated in a next frame.

It is conventionally assumed that more light output in a display is better. However, the present invention relies on the fact that a trade off has been introduced between output luminance and dynamic resolution, the image display apparatus of the present invention giving improved dynamic resolution.

In a first embodiment of the invention, the control means is a moving shutter control means in the illumination path of the display apparatus. The image display apparatus may be one in which the image display means is a direct view liquid crystal transmissive display apparatus, and in which the moving shutter control means is positioned between the direct view liquid crystal transmissive display apparatus and a backlight illuminator.

The moving shutter control means may comprise a multi-element liquid crystal.

The moving shutter control means may be such that its shutter array is synchronised to a video in order for the moving shutter control means to scroll down the light output during each frame interval. This would have the effect of superimposing a decay characteristic similar to a cathode ray tube display on to the light output. The shutter array may be synchronised to a vertical synchronization pulse of the incoming video.

In a second embodiment of the invention, the control means is a modulator control means.

The modulator control means may comprise a multi-element liquid crystal shutter. The multi-element liquid crystal shutter may be a ferro-electric liquid crystal shutter array with polarisers attached. Alternatively, the multi-element liquid crystal shutter may make use of transreflective film in place of a conventional polariser, reflecting the unwanted illuminating light back into the illumination system of the display apparatus, thus minimising the amount of light lost in the light modulation process.

The image display apparatus may include a projector and a screen.

In a third embodiment of the invention, the image display means is a direct view liquid crystal transmissive display apparatus, and in which the control means is a liquid crystal shutter modulator.

The liquid crystal shutter modulator may be positioned before a direct view liquid crystal transmissive display panel.

Embodiments of the invention will now be described solely by way of example and with reference to the accompanying drawings in which:

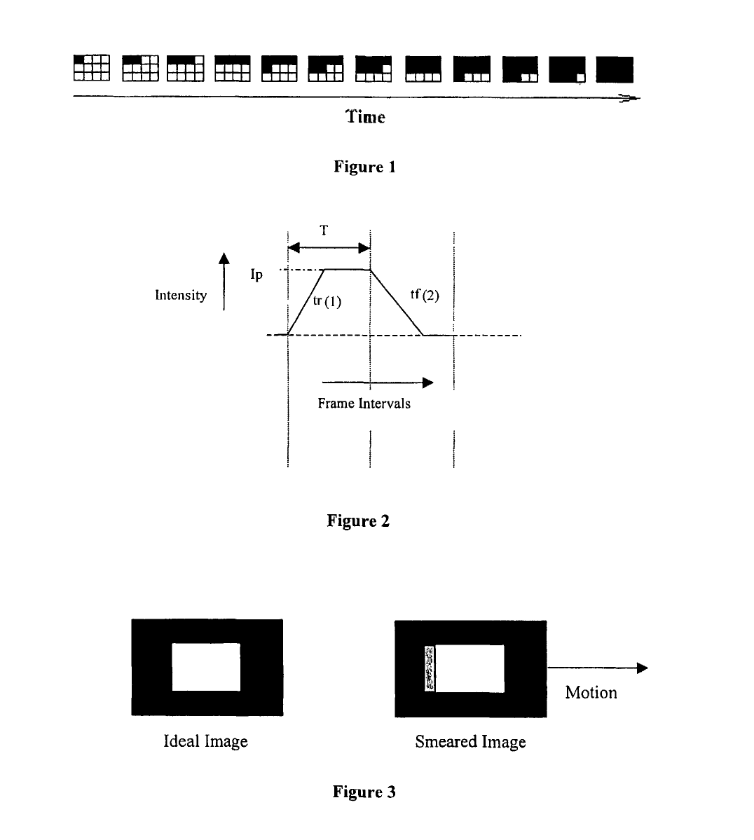

FIG. 1 shows a sequentially scanned liquid crystal display array;

FIG. 2 shows linear rise and fall times;

FIG. 3 illustrates the appearance of a white square on a black background, subject to smear along the direction of motion;

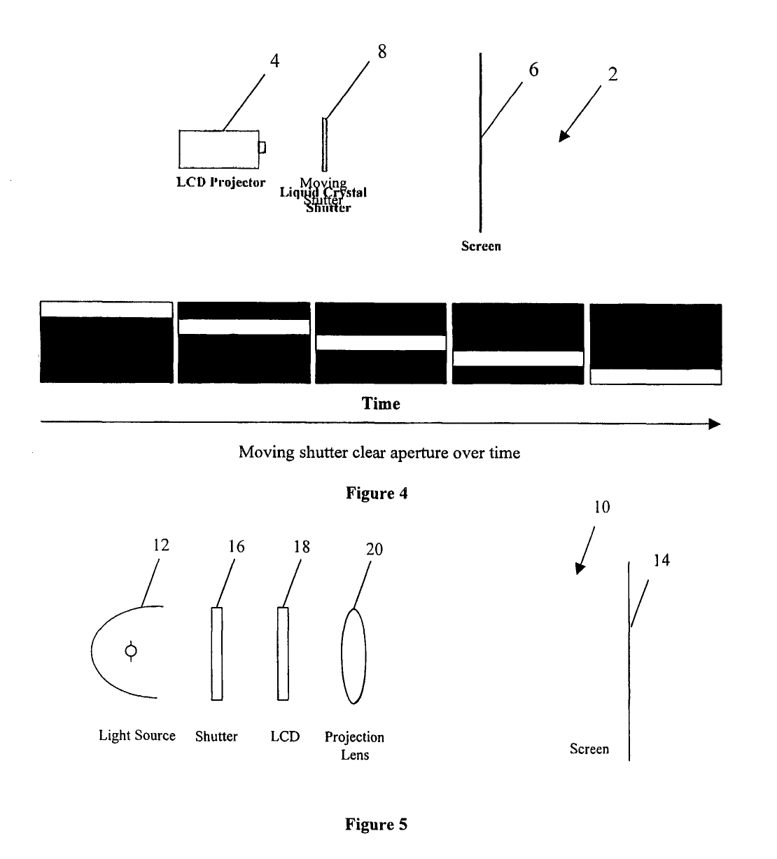

FIG. 4 shows image display apparatus utilising a liquid crystal shutter in a projected image path;

FIG. 5 shows first image display apparatus of the present invention, showing different positions of a shutter;

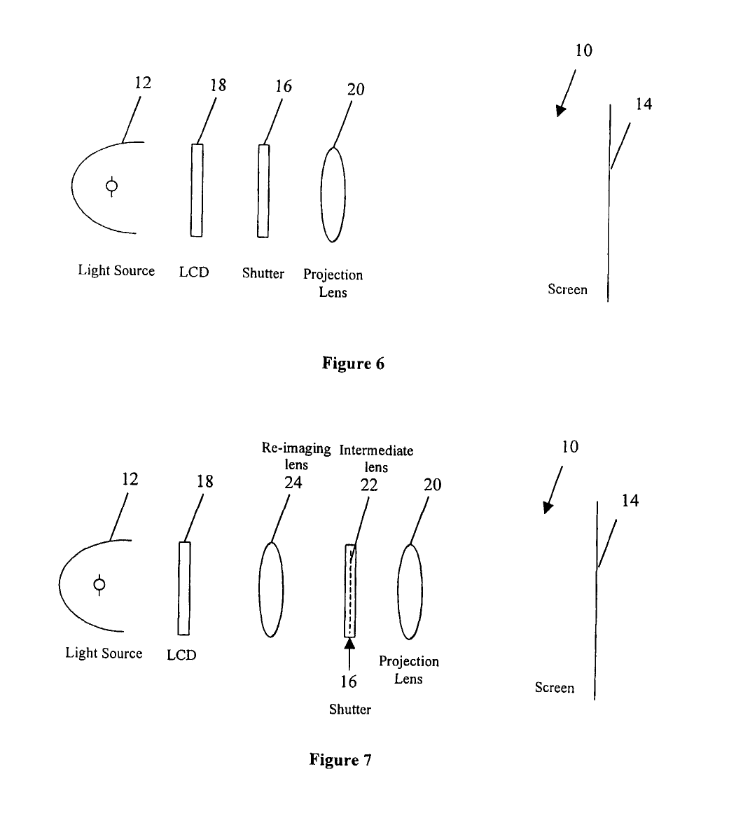

FIG. 6 shows second image display apparatus of the present invention in the form of a direct view liquid crystal transmissive display device;

FIG. 7 shows third image display apparatus of the invention;

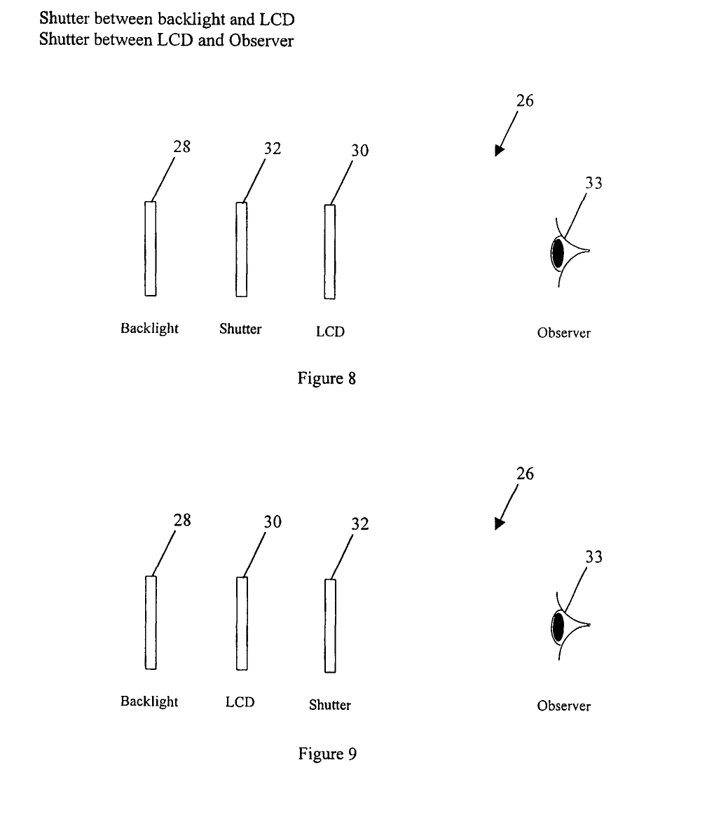

FIGS. 8 and 9 show fourth image display apparatus of the present invention in the form of a direct view liquid crystal transmissive device display, and show two different positions for a shutter;

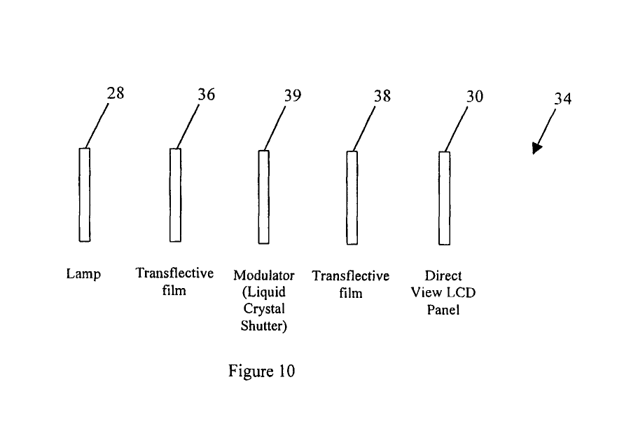

FIG. 10 shows fifth image display apparatus of the present invention and shows the use of transreflective film; and

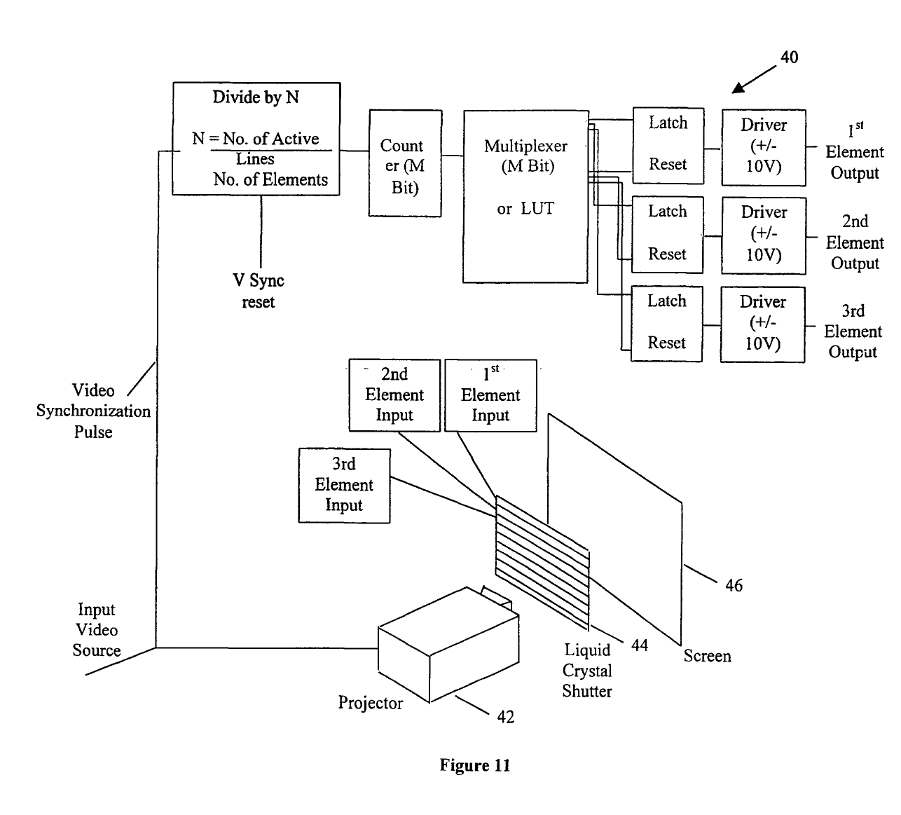

FIG. 11 shows how the image display apparatus shown in FIGS. 8 and 9 is able to be synchronised to a vertical synchronization pulse of an incoming video signal.

Referring to FIG. 1, there is shown a 4 by 3 sequentially scanned liquid crystal display array. As mentioned above, fixed matrix technology such as liquid crystal displays addresses individual pixels within a panel. The resolution of the display is fixed and dependent on the number of pixels within the panel. Any source video formats not of the native panel resolution require scan conversion before the display. One particular class of liquid crystal display that is in common use is referred to as sequentially scanned, where each pixel is addressed in turn as part of a line and frame structure as shown in FIG. 1. As also mentioned above, when each liquid crystal display element that forms the pixel has a new polarisation state set which, in combination with the pre and post polarisers, results in a pixel intensity modulated by the source video signal. Whilst this technology is highly successful in mainstream presentation applications, it suffers from poor rendition of dynamic scenes. This is due to the two characteristics mentioned above.

FIG. 2 shows a plot of instantaneous luminance against time for a display pixel that is instructed to illuminate for one frame and then extinguish. For convenience, the plot is for a pixel that is addressed at the very start of the frame period. For simplicity, intensity rise and fall is shown as linear, whereas in practice it would be more complex.

Referring now to FIG. 3, if a white square moves across a black background on a display with zero order hold characteristics, the leading and trailing edges will become diffuse and less bright. This gives the illusion of elongating the square along the direction of motion and is known as smear. The smear effect is variable depending on the velocity of the moving square.

Referring to FIG. 4, there is shown image display apparatus 2 comprising a liquid crystal display projector 4 and a screen 6. The image display apparatus 2 also comprises control means 8 for eliminating or reducing smear caused by a zero order hold characteristic of the image display apparatus 2. The control means 8 is such that it eliminates or reduces the zero hold characteristic by superimposing a decay characteristic on to light output of the image display apparatus 2. The control means 8 is such that it superimposes the decay characteristic by reducing the pixel intensity before the pixel intensity is updated in a next frame.

The control means shown in FIG. 4 is a moving shutter control means 8. The moving shutter control means 8 is positioned in a projection path from the liquid crystal display projector 4. The control means 8 as shown in FIG. 4 is a liquid crystal moving shutter control means 8. FIG. 4 shows the liquid crystal shutter positions over time. The moving shutter control means may be other than the liquid crystal moving shutter control means.

Referring now to FIG. 5, there is shown image display apparatus 10 comprising a light source 12 and a screen 14. The image display apparatus 10 also comprises control means in the form of a liquid crystal shutter 16 which is positioned between the light source 12 and a liquid crystal display panel 18. The image display apparatus 10 also includes an imaging lens 20 as shown.

FIG. 6 shows the image display apparatus 10 of FIG. 5 but with the liquid crystal shutter 16 positioned between the liquid crystal display panel 18 and the projection lens 20. The liquid crystal shutter 16 is out of focus when positioned as shown in FIGS. 5. and 6. However, this out of focus effect may be acceptable. In situations where the liquid crystal shutter 16 must be in focus, then an intermediate image 22 of the liquid crystal display panel 18 may be formed as shown in FIG. 7. It will be seen that the shutter 16 has been placed in the plane containing the intermediate image 22. A re-imaging lens 24 is employed as shown.

FIGS. 8 and 9 show image display apparatus 26 comprises a backlight 28, a direct view liquid crystal transmissive display panel 30, and control means in the form of a liquid crystal shutter modulator 32. The liquid crystal shutter modulator 32 may be employed at the position shown in FIG. 8 or at the position shown in FIG. 9. The liquid crystal shutter modulator 32 may be a multi-element ferro-electric liquid crystal shutter array with polarisers attached. An observer is shown by an eye 33.

FIG. 10 shows image display apparatus 34 which comprises the lamp 28 and the direct view liquid crystal display panel 30 of FIGS. 8 and 9. However, the liquid crystal display shutter modulator 32 of FIGS. 8 and 9 has been replaced by transreflective film 36, 38 positioned either side of a liquid crystal shutter modulator 39. A light recycling system can thus be produced in order to increase the efficiency of the light path. This effect is achievable as the transreflective film 36, 38 transmit one linear polarisation of light, and reflect the orthogonal polarisation.

FIG. 10 illustrates the general principle that a shutter lets in light through its clear aperture and would normally block or absorb the rest. This is not efficient. The efficiency can be improved by reflecting the light that is not transmitted by the clear aperture. This light can then be re-cycled to some extent so that some of it will eventually have a second chance of getting through the clear aperture. In principle, it is possible to do this for both projection and direct view. One possible means of achieving this is by using transreflective film, which reflects light of the unwanted polarisation rather than absorbing it.

The image display apparatus 26 shown in FIGS. 8 and 9 may be implemented as shown in FIG. 11. More specifically, by synchronising the shutter array to the video signal, a travelling shutter could be scrolled down the light output during each frame interval, therefore having the effect of superimposing a decay characteristic similar to a cathode ray tube display on to the light output. In FIG. 10, the illustrated image display apparatus 40 is synchronised to the vertical synchronization pulse of the incoming video signal as shown. Also shown in FIG. 10 is a projector 42, a liquid crystal shutter 44, and a screen 46.

It is to be appreciated that the embodiments of the invention described above with reference to the accompanying drawings have been given by way of example only and that modifications may be effected. Thus, for example, other types of image display apparatus than those shown in the drawings may be employed. The shutter clear aperture can move continuously or in discrete steps. The width of the clear aperture (as a fraction of the full width of the shutter) can be varied to trade-off smear suppression again light loss. The phasing and width of the clear aperture needs to take into account the rise and fall times of the liquid crystal display. Whilst a liquid crystal display is preferred, other devices may be employed. The shutter need not be a single device. Thus, for example, the shutter may be two devices in series, one contributing to the leading edge of the clear aperture and the other to the trailing edge. With a ferro-electric liquid crystal display shutter, best contrast (between clear and opaque areas) may be obtained with a 50% clear-opaque ratio.

1. Image display apparatus for improving the display of moving images, which image display apparatus comprises control means for eliminating or reducing smear caused primarily by a zero-order hold characteristic of a light-valve image display device, the control means being such that it eliminates or reduces the zero-order hold characteristic by superimposing a decay characteristic onto light incident upon the light-valve image display device, and the control means being such that it superimposes the decay characteristic by reducing the pixel intensity before the pixel intensity is updated in a next frame.

2. Image display apparatus according to claim 1 in which the control means is a moving shutter control means in the illumination path of the display apparatus.

3. Image display apparatus according to claim 2 in which the image display means is a direct view liquid crystal transmissive display apparatus, and in which the moving shutter control means is positioned between the direct view liquid crystal transmissive display apparatus and a backlight illuminator.

4. Image display apparatus according to claim 2 or claim 3 in which the moving shutter control means comprises a multi-element liquid crystal.

5. Image display apparatus according to any one of claims 2-4 in which the moving shutter control means is such that its shutter array is synchronised to a video in order for the moving shutter control means to scroll down the light output during each frame interval.

6. Image display apparatus according to claim 5 in which the shutter array is synchronised to a vertical synchronization pulse of the incoming video.

7. Image display apparatus according to claim 1 in which the control means is a modulator control means.

8. Image display apparatus according to claim 7 in which the modulator control means comprises a multi-element liquid crystal shutter.

9. Image display apparatus according to claim 8 in which the multi-element liquid crystal shutter is a ferro-electric liquid crystal shutter array with polarisers attached.

10. Image display apparatus according to claim 8 in which the multi-element liquid crystal shutter makes use of transreflective film in place of a conventional polariser, reflecting the unwanted illuminating light back into the illumination system of the display apparatus, thus minimising the amount of light lost in the light modulation process.

11. Image display apparatus according to any one of claims 2-10 and including a projector and a screen.

12. Image display apparatus according to claim 3 in which the image display means is a direct view liquid crystal transmissive display apparatus, and in which the control means is a liquid crystal shutter modulator.

13. Image display apparatus according to claim 12 in which the liquid crystal shutter modulator is positioned before a direct view liquid crystal transmissive display panel.
